(19) United States
(12) Patent Application Publication
(10) Pub. No.: US 2025/0253362 A1
(43) Pub. Date: Aug. 7, 2025

(54) COOLING SYSTEM FOR FUEL CELL ONBOARD A VEHICLE INCLUDING AUXILIARY EVAPORATIVE COOLER

(71) Applicant: ZeroAvia Ltd., Kemble (GB)

(72) Inventors: Seied Masoud Ameli, Swindon (GB); Michael Patterson, Bath (GB); Matthew Graham Legg, Swindon (GB); Christian Bailey, Palo Alto, CA (US)

(73) Assignee: ZeroAvia Ltd., Kemble (GB)

(21) Appl. No.: 18/857,126

(22) PCT Filed: Apr. 29, 2022
(86) PCT No.: PCT/GB2022/051111

§ 371 Date: Oct. 15, 2024

(51) Int. Cl. H01M 8/04007; B64D 27/355; B64D 33/08; H01M 8/04119; H01M 8/04746

(52) U.S. Cl. CPC H01M 8/04059; B64D 27/355; B64D 33/08; H01M 8/04052; H01M 8/04164; H01M 8/04768; H01M 2250/20

(57) ABSTRACT

A cooling system for a fuel cell onboard a vehicle includes a coolant circuit and an auxiliary evaporative cooler. The coolant circuit is configured to circulate a coolant including a phase change material therethrough and through a portion of the fuel cell to absorb heat from the fuel cell. The auxiliary evaporative cooler includes a coolant channel in fluid communication with the coolant circuit, an airflow channel in fluid communication with an ambient environment, and a selectively permeable membrane that physically separates the coolant channel from the airflow channel and is selectively permeable to the phase change material. The auxiliary evaporative cooler is configured to evaporatively cool the coolant flowing through the coolant channel by promoting evaporation and transport of the phase change material from the coolant flowing through the coolant channel, through the selectively permeable membrane, and into an ambient airflow flowing through the airflow channel.

### FIELD

The present disclosure relates to cooling systems for fuel cells onboard vehicles and, more particularly, to cooling systems for fuel cells that use ambient air as a heat-transfer medium.

### BACKGROUND AND SUMMARY

This section provides background information related to the present disclosure which is not necessarily prior art. This section provides a general summary of the disclosure and is not a comprehensive disclosure of its full scope or all of its features.

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for fuel cell-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

In fuel cell-powered aircraft, the power output demanded of the fuel cells- and the amount of waste heat generated by the fuel cells—is oftentimes greatest during take-off and climb. Waste heat generated during operation of powered aircraft may be dissipated by positioning an air-cooled heat exchanger in an ambient airflow path through the aircraft. Directing ambient air to flow through the aircraft (instead of around the aircraft) when the aircraft is moving creates drag, with the amount of drag experienced by the aircraft being proportional to the volume of ambient air directed through the aircraft (and through the heat exchanger). In practice, the volume of the air-cooled heat exchanger (and the volume of air directed through the heat exchanger) may be selected to accommodate the most demanding cooling requirements of the aircraft, which may occur when the aircraft is operating under high load conditions, e.g., during take-off and climb. However, sizing the heat exchanger in this way may cause the aircraft to experience an unnecessarily large amount of drag when the aircraft is operating under low load conditions, e.g., during cruise, when minimal waste heat dissipation is needed. In addition, when cooling requirements are low, the presence of an oversized heat exchanger onboard the aircraft adds unnecessary weight and bulk to the aircraft.

It may be desirable to develop a system that can be used to effectively remove waste heat from a fuel cell onboard a vehicle during high load events without increasing the amount of drag experienced by the vehicle when the vehicle is operating under normal or low load conditions.

A cooling system for a fuel cell onboard a vehicle is disclosed. The cooling system comprises a coolant circuit defining a coolant passageway and an auxiliary evaporative cooler. The coolant circuit is configured to circulate a coolant including a phase change material through the coolant passageway and through a portion of the fuel cell to absorb heat from the fuel cell. The auxiliary evaporative cooler comprises an inlet, an outlet, a coolant channel, an airflow channel, and a selectively permeable membrane that physically separates the coolant channel from the airflow channel. The inlet is configured to receive an airflow from an ambient environment. The outlet in fluid communication with the inlet and with the ambient environment. The airflow channel is in fluid communication with the inlet and the outlet. The coolant channel is in fluid communication with the coolant circuit. The selectively permeable membrane is selectively permeable to the phase change material in the coolant. The auxiliary evaporative cooler is configured to evaporatively cool the coolant flowing through the coolant channel by promoting evaporation and transport of the phase change material from the coolant flowing through the coolant channel, through the selectively permeable membrane, and into the airflow flowing through the airflow channel.

The cooling system may further comprise a thermal energy storage chamber in fluid communication with the airflow channel. The thermal energy storage chamber may be configured to store thermal energy released from the coolant flowing through the coolant channel in the form of latent heat.

The thermal energy storage chamber may be configured to store phase change material evaporated from the coolant flowing through the coolant channel when the vehicle is operating under high load conditions and to gradually discharge the phase change material therefrom when the vehicle is operating under low load conditions.

During a high load event, an additional amount of thermal energy may be generated by the fuel cell, as compared to when the vehicle is operating under normal conditions or relatively low load conditions for the same duration, and the thermal energy storage chamber may be sized such that a thermal energy storage capacity of the thermal energy storage chamber is greater than or equal to the additional amount of thermal energy generated by the fuel cell during the high load event.

Storage of the phase change material within the thermal energy storage chamber may increase an evaporation rate of the phase change material from the coolant without increasing a volumetric flow rate of the airflow through the airflow channel.

The thermal energy storage chamber may reach a maximum energy storage capacity when the vapor pressure of the phase change material in the thermal energy storage chamber reaches the saturation vapor pressure of the phase change material.

The phase change material may comprise water. In such case, the selectively permeable membrane may comprise a hydrophobic polymer.

The cooling system may further comprise a water recovery system configured to: (i) condense water vapor from a processed airflow exiting the outlet of the auxiliary evaporative cooler and to return the condensed water vapor to the coolant circuit, or (ii) to condense water vapor from a cathode exhaust gas stream generated by operation of the fuel cell and to supply the condensed water to the coolant circuit.

The cooling system may further comprise a plenum including an inlet and an outlet in fluid communication with the ambient environment. The inlet of the plenum may be in fluid communication with the inlet of the auxiliary evaporative cooler and the outlet of the plenum may be in fluid communication with the outlet of the auxiliary evaporative cooler.

The coolant circuit may comprise a first bypass configured to direct the coolant circulating through the coolant passageway to selectively bypass the auxiliary evaporative cooler, and the plenum may comprise a second bypass configured to direct the airflow flowing through the plenum to selectively bypass the auxiliary evaporative cooler.

The cooling system may further comprise a controller configured to control operation of the first bypass and the second bypass such that (i) the airflow and the coolant pass through the auxiliary evaporative cooler when the vehicle is operating under high load conditions, and (ii) the airflow and the coolant bypass the auxiliary evaporative cooler when the vehicle is operating under low load conditions.

The auxiliary evaporative cooler may be disposed within the plenum.

The inlet of the plenum may be configured to receive the airflow from the ambient environment when the vehicle is moving.

The vehicle may be an aircraft, the airflow may comprise ram air, and the plenum may be defined within a wing of the aircraft.

The cooling system may further comprise a liquid-to-air heat exchanger in fluid communication with the inlet and the outlet of the plenum. The liquid-to-air heat exchanger may be configured to transfer heat from the coolant circulating through the coolant passageway of the coolant circuit to the airflow flowing through the plenum.

In some embodiments, the liquid-to-air heat exchanger and the auxiliary evaporative cooler may be arranged in series in a path of the airflow through the plenum.

In some embodiments, the liquid-to-air heat exchanger and the auxiliary evaporative cooler may be arranged in parallel in a path of the airflow through the plenum.

The cooling system may further comprise a third heat exchanger coupled to the fuel cell. The third heat exchanger may be configured to transfer heat from the fuel cell to the coolant circulating through the coolant passageway of the coolant circuit.

The fuel cell may comprise an anode configured to receive a hydrogen-containing reactant gas and to discharge a hydrogen-containing exhaust gas stream and a cathode configured to receive an oxygen-containing reactant gas and to discharge a water vapor-containing exhaust gas stream.

The cooling system may further comprise a coolant header tank in fluid communication with the coolant passageway of the coolant circuit.

The cooling system may further comprise a vacuum pump and evacuation system configured to generate a sub-atmospheric pressure environment in the coolant header tank.

The cooling system may further comprise a pump configured to circulate the coolant through the coolant passageway of the coolant circuit.

A cooling system for a fuel cell onboard a vehicle is disclosed. The cooling system comprises a plenum, a coolant circuit, an auxiliary evaporative cooler, and a thermal energy storage chamber. The plenum includes an inlet and an outlet in fluid communication with an ambient environment. The inlet of the plenum is configured to receive an airflow from the ambient environment. The coolant circuit defines a coolant passageway and is configured to circulate an aqueous coolant through the coolant passageway and through a portion of the fuel cell to absorb heat from the fuel cell. The auxiliary evaporative cooler comprises a coolant channel, an airflow channel, and a selectively permeable membrane that physically separates the coolant channel from the airflow channel. The coolant channel is in fluid communication with the coolant circuit. The airflow channel is in fluid communication with the inlet and the outlet of the plenum. The selectively permeable membrane is selectively permeable to water vapor. The thermal energy storage chamber is in fluid communication with the airflow channel of the auxiliary evaporative cooler. The auxiliary evaporative cooler is configured to evaporatively cool the aqueous coolant flowing through the coolant channel by promoting evaporation and transport of water vapor from the aqueous coolant flowing through the coolant channel, through the selectively permeable membrane, and into the airflow flowing through the airflow channel. The thermal energy storage chamber is configured to store thermal energy released from the aqueous coolant flowing through the coolant channel in the form of latent heat.

The thermal energy storage chamber may be configured to store water vapor evaporated from the aqueous coolant flowing through the coolant channel when the vehicle is operating under high load conditions and to gradually discharge the water vapor therefrom when the vehicle is operating under low load conditions.

Storage of the water vapor within the thermal energy storage chamber may increase the rate at which thermal energy is removed from the coolant flowing through the coolant channel without increasing a volumetric flow rate of the airflow flowing through the airflow channel.

The thermal energy storage chamber may reach a maximum energy storage capacity when the vapor pressure of water in the thermal energy storage chamber reaches the saturation vapor pressure of water.

During a high load event, an additional amount of thermal energy may be generated by the fuel cell, as compared to when the vehicle is operating under normal conditions or relatively low load conditions for the same duration, and the thermal energy storage chamber may be sized such that a thermal energy storage capacity of the thermal energy storage chamber is greater than or equal to the additional amount of thermal energy generated by the fuel cell during the high load event.

The aqueous coolant may comprise a mixture of water and at least one of ethylene glycol and propylene glycol.

The vehicle may be an aircraft, the airflow may comprise ram air, the plenum may be defined within a wing of the aircraft, and the thermal energy storage chamber may be disposed within the plenum.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a process flow diagram of a cooling system for a fuel cell onboard a vehicle, the cooling system comprising a coolant circuit, a plenum in fluid communication with an ambient environment, with a liquid-to-air heat exchanger and an auxiliary evaporative cooler serially arranged within an ambient airflow path through the plenum.

FIG. 2 is a schematic depiction of an aircraft including a fuel cell onboard the aircraft.

FIG. 3 is a schematic cross-sectional view of the auxiliary evaporative cooler of FIG. 1, wherein the auxiliary evaporative cooler is disposed in a plenum defined in a wing of the aircraft of FIG. 2.

FIG. 4 is a schematic cross-sectional view of the auxiliary evaporative cooler of FIG. 1, depicting a coolant channel, an airflow channel, a selectively permeable membrane physically separating the coolant channel from the airflow channel, and a thermal energy storage chamber in fluid communication with the airflow channel.

FIG. 5 is a schematic cross-sectional view of another embodiment of an auxiliary evaporative cooler including a coolant channel, an airflow channel, a selectively permeable membrane physically separating the coolant channel from the airflow channel, and a thermal energy storage chamber at least partially defined by the airflow channel.

FIG. 6 is a schematic cross-sectional view of another embodiment of an auxiliary evaporative cooler including a plurality of coolant channels, a plurality of airflow channels, and a plurality of selectively permeable membranes, with each of the plurality of coolant channels being physically separated from an adjacent one of the plurality of airflow channels by one of the plurality of selectively permeable membranes.

FIGS. 7A and 7B are schematic cross-sectional views of a plenum in fluid communication with an ambient environment, with a liquid-to-air heat exchanger and an auxiliary evaporative cooler serially arranged within an airflow path through the plenum, wherein the plenum includes a bypass (FIG. 5B) that directs ambient air flowing through the plenum to selectively bypass the auxiliary evaporative cooler.

FIG. 8 is a schematic cross-sectional view of a plenum in fluid communication with an ambient environment, with a liquid-to-air heat exchanger and an auxiliary evaporative cooler arranged in parallel within an ambient airflow path through the plenum.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

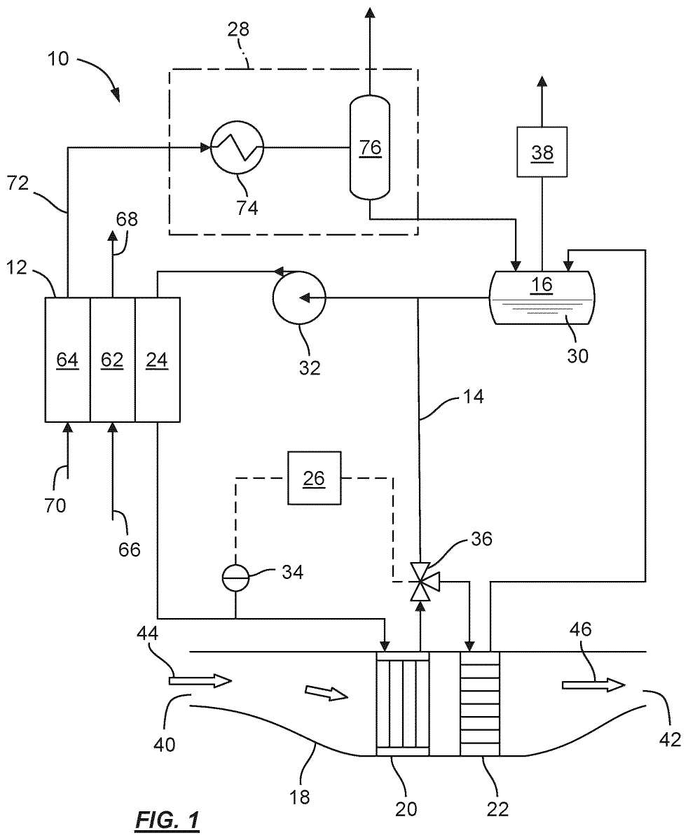

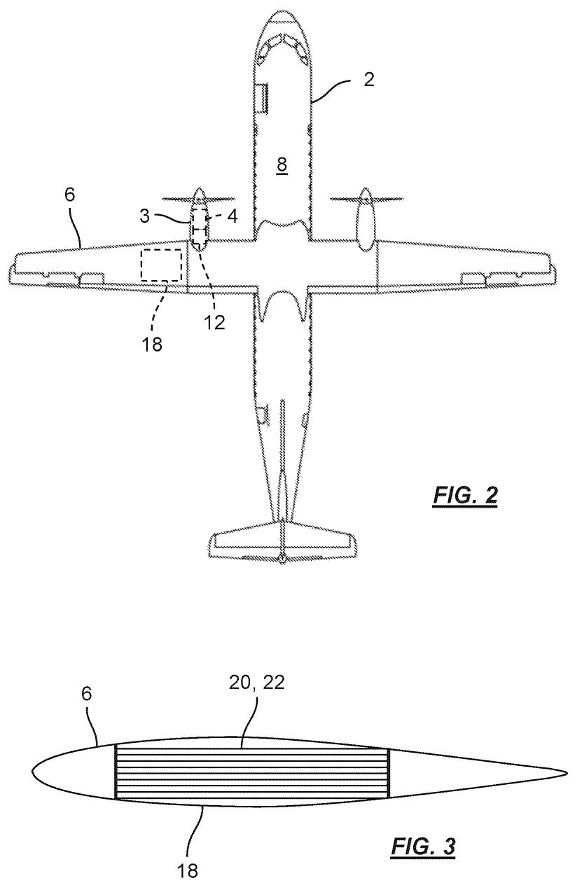

FIG. 1 depicts a process flow diagram of a cooling system 10 for a fuel cell 12 onboard a vehicle. As shown in FIG. 2, the fuel cell 12 may be located onboard an aircraft 2 that is powered at least in part by an electric motor 4. In some embodiments, the fuel cell 12 and/or the electric motor 4 may be disposed in a wing 6 of the aircraft 2. In some embodiments, the fuel cell 12 and/or the electric motor 4 may be disposed in a streamlined enclosure or nacelle 3 of the aircraft 2, in a fuselage 8 of the aircraft 2, or in any other part of the aircraft 2.

The cooling system 10 may be configured to maintain the fuel cell 12 within an acceptable operating temperature range, for example, by transferring waste heat generated by the fuel cell 12 away from the fuel cell 12 to a cooling medium. The cooling system 10 may be configured to accommodate varying cooling requirements of the aircraft 2. To accomplish this, for example, the cooling system 10 may vary the amount of heat transferred away from the fuel cell 12, for example, to accommodate situations when the vehicle is operating under normal operating conditions (e.g., during cruise), when the vehicle is operating under low load conditions (e.g., during descent), or when the vehicle is operating under high load conditions (e.g., during take-off and climb). In some embodiments, when the fuel cell 12 is in the process of warming up to a desired operating temperature, the cooling system 10 may operate without transferring heat away from the fuel cell 12 until the desired operating temperature is reached.

The presently disclosed cooling system 10 will be described more fully hereinbelow with reference to the exemplary embodiment depicted in FIG. 1. The presently disclosed cooling system 10, however, is not limited to the arrangement shown in FIG. 1 and may be embodied in different forms. In addition, in the following description, the cooling system 10 is described with reference to use in an aircraft 2; however, the presently disclosed cooling system 10 is not limited to aircraft and may be used in a variety of different vehicle applications. The scope of the present disclosure is defined by the claims and their equivalents.

The cooling system 10 depicted in FIG. 1 includes a coolant circuit 14, a coolant header tank 16, a plenum 18, a liquid-to-air heat exchanger 20, an auxiliary evaporative cooler 22, a fuel cell heat exchanger 24 coupled to the fuel cell 12, a controller 26, and an optional water recovery system 28. In the embodiment depicted in FIG. 1, the coolant circuit 14 defines a passageway for circulation of a coolant 30 through the cooling system 10 and includes a coolant pump 32, one or more temperature sensors 34, and a bypass valve 36.

The coolant 30 is formulated to assist in the transfer of thermal energy between various components of the cooling system 10 and in the discharge of waste heat from the cooling system 10 to an ambient environment. For example, the coolant 30 may comprise a heat transfer fluid having a high specific heat capacity and good thermal, chemical, electrical (e.g., not electrically conductive, dielectric), and mechanical compatibility with the other components of the cooling system 10 and with the fuel cell 12. The coolant 30 comprises and, in some embodiments, may consist essentially of a phase change material having a high latent heat of vaporization and the ability to undergo a phase change, i.e., from a liquid to a gas and vice versa, when subjected to certain temperature and pressure conditions generated within the cooling system 10. The coolant 30, including the phase change material, may be an aqueous or nonaqueous fluid. In some embodiments, the phase change material included in the coolant 30 may comprise or consist essentially of water. In some embodiments, the phase change material included in the coolant 30 may comprise or consist essentially of hexane, methanol, ethanol, phenol, butanol, iso-propanol, n-propanol, and combinations thereof. In some embodiments, the coolant 30 may comprise or consist essentially of water. The coolant 30 may comprise one or more additives selected to impart certain desirable properties to the coolant 30, e.g., a relatively high boiling point and/or freezing point. Examples of additives include ethylene glycol and/or propylene glycol.

In some embodiments, the coolant 30 may be formulated so that the coolant 30 exhibits a boiling point greater than the operating temperature and pressure of the passageway defined by the coolant circuit 14, the coolant header tank 16, the liquid-to-air heat exchanger 20, the auxiliary evaporative cooler 22, and the fuel cell heat exchanger 24. As such, the coolant 30 circulating through the coolant circuit 14 and through the coolant header tank 16, the liquid-to-air heat exchanger 20, the auxiliary evaporative cooler 22, and the fuel cell heat exchanger 24 may generally be in the form of a liquid. At the same time, the coolant 30 may be formulated so that the phase change material included in the coolant 30 exhibits a boiling point less than the operating temperature and pressure of the auxiliary evaporative cooler 22 and/or of the plenum 18 so that, during operation of the auxiliary evaporative cooler 22, at least a portion of the phase change material may evaporate from the coolant 30 and thereby cool the portion of the coolant 30 that remains in liquid phase.

The coolant pump 32 may be configured to circulate the coolant 30 through the coolant circuit 14. The one or more temperature sensors 34 may be configured to sense the temperature of the coolant 30 in the coolant circuit 14. As shown in FIG. 1, a temperature sensor 34 may be positioned downstream of the fuel cell heat exchanger 24 and upstream of the bypass valve 36 and may be configured to sense the temperature of the coolant 30 exiting the fuel cell heat exchanger 24 and to transmit a signal to the controller 26 indicative of the temperature of the coolant 30 at that specific location within the coolant circuit 14. In some embodiments, a temperature sensor (not shown) may be positioned upstream of the fuel cell heat exchanger 24 and downstream of the coolant header tank 16 and/or the coolant pump 32 in the passageway defined by the coolant circuit 14. In such case, the temperature sensor may be configured to sense the temperature of the coolant 30 prior to entering the fuel cell heat exchanger 24 and may be configured to transmit a signal to the controller 26 indicative of the temperature of the coolant 30 at that specific location within the passageway defined by the coolant circuit 14.

The bypass valve 36 may be positioned within a flow path of the coolant 30 in the coolant circuit 14, between the liquid-to-air heat exchanger 20 and the auxiliary evaporative cooler 22. In such an arrangement, the bypass valve 36 may be operable to control the flow of the coolant 30 exiting the liquid-to-air heat exchanger 20 so that the coolant 30 is either directed to flow through the auxiliary evaporative cooler 22 or is directed to bypass the auxiliary evaporative cooler 22. In some embodiments, for example, when the fuel cell 12 is in the process of warming up to a desired operating temperature, coolant 30 flowing through the coolant circuit 14 may be directed to bypass the fuel cell heat exchanger 24. In such case, the cooling system 10 may operate without transferring heat away from the fuel cell 12 until the fuel cell 12 reaches a desired operating temperature.

In some embodiments, the controller 26 may control operation of the bypass valve 36 based upon information received from the one or more temperature sensors 34. For example, if the temperature sensor 34 indicates that the temperature of the coolant 30 is below a defined temperature limit, the controller 26 may control operation of the bypass valve 36 so that the coolant 30 exiting the liquid-to-air heat exchanger 20 bypasses the auxiliary evaporative cooler 22 and does not flow through the auxiliary evaporative cooler 22. On the other hand, if the temperature sensor 34 indicates that the temperature of the coolant 30 is above a defined temperature limit, the controller 26 may control operation of the bypass valve 36 so that the coolant 30 exiting the liquid-to-air heat exchanger 20 is directed through the auxiliary evaporative cooler 22.

The coolant header tank 16 contains a volume of the coolant 30 and may help accommodate thermal expansion of the coolant 30 and ensure positive pressure is maintained within the coolant circuit 14 during operation of the cooling system 10. In some embodiments, the coolant header tank 16 may be in fluid communication with a vacuum pump and evacuation system 38. The vacuum pump and evacuation system 38 may create a sub-atmospheric pressure environment within the coolant header tank 16 in the ullage above the coolant 30 in the coolant header tank 16. In some embodiments, the vacuum pump and evacuation system 38 may include a constricted section, for example, to create a venturi effect.

The plenum 18 includes an inlet 40 and an outlet 42 in fluid communication with an ambient environment outside the aircraft 2. The inlet 40 of the plenum 18 is configured to receive an airflow 44 of ambient air from the ambient environment and the outlet 42 is configured to discharge a processed airflow 46 from the plenum 18, for example, to the ambient environment. The airflow 44 introduced into the inlet 40 of the plenum 18 may be “ram air” and may be generated when the aircraft 2 is moving. The plenum 18 may be constructed and arranged to direct the airflow 44 through the aircraft 2 and through one or more components disposed within an airflow path through the plenum 18. As shown in FIGS. 2 and 3, in some embodiments, the plenum 18 may be defined in the wing 6 of the aircraft 2. In other aspects, the plenum 18 may be defined in the fuselage 8 of the aircraft 2 or in any other part of the aircraft 2, for example, in a nacelle 3 of the aircraft 2. In some embodiments, the cross-sectional area of the inlet 40 of the plenum 18 (perpendicular to a flow direction of the airflow 44) may be controlled or adjusted, for example, by the controller 26. For example, in some embodiments, the cross-sectional area of the inlet 40 of the plenum 18 may be increased when the aircraft 2 is operating under relatively high load conditions and may be decreased when the aircraft 2 is operating under relatively low load conditions to reduce aerodynamic drag.

The liquid-to-air heat exchanger 20 depicted in FIG. 1 is positioned in the airflow path defined between the inlet 40 and the outlet 42 of the plenum 18 and is configured to promote indirect heat transfer between the coolant 30 and the airflow 44 passing therethrough. The liquid-to-air heat exchanger 20 may include an airflow channel and a coolant channel separated by a thermally conductive impervious barrier (not shown). The airflow channel of the liquid-to-air heat exchanger 20 may be in fluid communication with the inlet 40 and the outlet 42 of the plenum 18, and the coolant channel of the liquid-to-air heat exchanger 20 may be in fluid communication with the coolant 30 circulating through the coolant circuit 14. In some embodiments, the airflow channel of the liquid-to-air heat exchanger 20 may be in fluid communication with the inlet 40 and the outlet 42 of the plenum 18 but the liquid-to-air heat exchanger 20 may not be disposed directly within the plenum 18. In the liquid-to-air heat exchanger 20, heat may be transferred from the coolant 30 to the barrier disposed between the airflow channel and the coolant channel by convection, heat may be transferred through the barrier by conduction, and heat may be transferred from the barrier to the airflow 44 by convection. Heat may be transferred from the coolant 30 to the airflow 44 within the liquid-to-air heat exchanger 20 to help remove waste heat generated by the fuel cell 12 from the cooling system 10. In some embodiments, the liquid-to-air heat exchanger 20 may be in the form of a double pipe, shell and tube, plate, plate and shell, adiabatic shell, finned tube, or plate and fin heat exchanger. The flow direction of the coolant 30 in the coolant channel may be parallel, opposite, or transverse to the flow direction of the airflow 44 in the airflow channel of the liquid-to-air heat exchanger 20.

In the embodiment depicted in FIG. 1, the liquid-to-air heat exchanger 20 is configured cool the coolant 30 by promoting indirect sensible heat transfer between the coolant 30 flowing through the coolant channel and the airflow 44 flowing through the airflow channel. In some embodiments, the liquid-to-air heat exchanger 20 may be configured to evaporatively cool the coolant 30 flowing through the coolant channel.

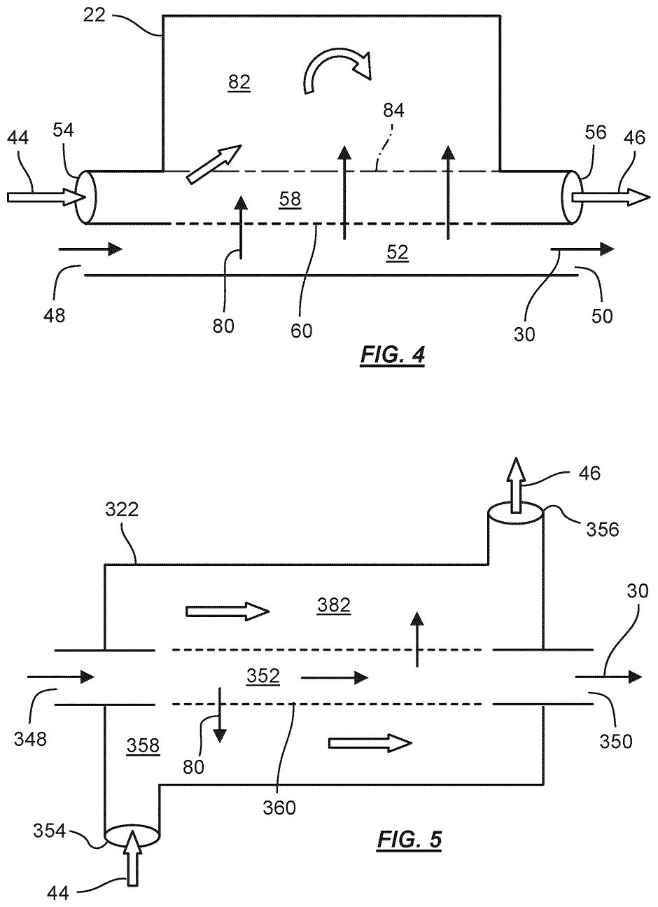

In the embodiment depicted in FIG. 1, the auxiliary evaporative cooler 22 is positioned in the airflow path defined between the inlet 40 and the outlet 42 of the plenum 18 and is configured to evaporatively cool the coolant 30 circulating through the coolant circuit 14 by promoting direct evaporation of a phase change material 80 (e.g., water) from the coolant 30, which absorbs thermal energy from the coolant 30 and effectively lowers the temperature of the coolant 30. In FIG. 1, the auxiliary evaporative cooler 22 and the liquid-to-air heat exchanger 20 are disposed within the plenum 18 and arranged in series in the airflow path defined between the inlet 40 and the outlet 42 of the plenum 18. As best shown in FIG. 4, the auxiliary evaporative cooler 22 may include a coolant inlet 48 and a coolant outlet 50 in fluid communication with the coolant circuit 14 and a coolant channel 52 defined between the coolant inlet 48 and the coolant outlet 50. At the same time, the auxiliary evaporative cooler 22 may include an airflow inlet 54 and an airflow outlet 56 in fluid communication with the inlet 40 and the outlet 42 of the plenum 18 and an airflow channel 58 defined between the airflow inlet 54 and the airflow outlet 56. In some embodiments, the airflow inlet 54 and the airflow outlet 56 of the auxiliary evaporative cooler 22 may be in fluid communication with the inlet 40 and the outlet 42 of the plenum 18 but the auxiliary evaporative cooler 22 may not be disposed directly within the plenum 18. In some embodiments, the auxiliary evaporative cooler 22 may be in the form of a double pipe, shell and tube, plate, plate and shell, adiabatic shell, or plate and fin heat exchanger. The flow direction of the coolant 30 in the coolant channel 52 may be parallel, opposite, or transverse to the flow direction of the airflow 44 in the airflow channel 58 of the auxiliary evaporative cooler 22.

In the auxiliary evaporative cooler 22, a selectively permeable membrane 60 is disposed between and physically separates the coolant channel 52 from the airflow channel 58. The selectively permeable membrane 60 is selectively permeable to the phase change material 80 contained in the coolant 30, meaning that the selectively permeable membrane 60 may allow the phase change material 80 to pass from the coolant 30 flowing through the coolant channel 52, through the membrane 60, and into the airflow 44 flowing through the airflow channel 58, while preventing or inhibiting other components or constituents of the coolant 30 from passing therethrough. In embodiments where the phase change material 80 comprises water, the selectively permeable membrane 60 is selectively permeable to water vapor, meaning that the selectively permeable membrane 60 may allow water vapor to pass from the coolant 30 flowing through the coolant channel 52, through the membrane 60, and into the airflow 44 flowing through the airflow channel 58, while preventing or inhibiting other components or constituents of the coolant 30 from passing therethrough. For example, the selectively permeable membrane 60 may be impermeable to organic compounds (e.g., ethylene glycol and/or propylene glycol) and inorganic salts and may prevent or inhibit such components of the coolant 30 from passing therethrough. In some embodiments, the selectively permeable membrane 60 may comprise or consist essentially of a hydrophobic polymer. Examples of hydrophobic polymers include polytetrafluoroethylene (PTFE), polyvinylidene Fluoride (PVDF), polypropylene (PP), and combinations thereof. In embodiments where the phase change material 80 comprises hexane, the selectively permeable membrane 60 may comprise or consist essentially of polyvinylidene fluoride (PVDF). In embodiments where the phase change material 80 comprises an organic alcohol, the selectively permeable membrane 60 may comprise or consist essentially of a polyether block amide.

The auxiliary evaporative cooler 22 is configured to cool the coolant 30 flowing through the coolant channel 52 by transferring thermal energy from the coolant 30 to the airflow 44 flowing through the airflow channel 58. In the auxiliary evaporative cooler 22, thermal energy transfer between the coolant 30 and the airflow 44 may occur by evaporation and, in some embodiments, by evaporation as well convection and/or conduction. For example, during operation of the auxiliary evaporative cooler 22, a temperature difference between the airflow 44 flowing through the airflow channel 58 and the coolant 30 flowing through the coolant channel 52 may drive sensible heat transfer between the airflow 44 and the coolant 30 via convection and conduction. When the coolant 30 exhibits a relatively high temperature, as compared to the temperature of the airflow 44, sensible heat transfer between the airflow 44 and the coolant 30 may increase the temperature of the airflow 44 and reduce the temperature of the coolant 30. The amount and rate of sensible heat transfer between the airflow 44 flowing through the airflow channel 58 and the coolant 30 flowing through the coolant channel 52 depends, at least in part, on the specific heat capacity of the airflow 44, the temperature difference between the airflow 44 and the coolant 30, and the mass flow rate of the airflow 44.

In addition, during operation of the auxiliary evaporative cooler 22, the difference between the vapor pressure of the phase change material 80 in the airflow 44 flowing through the airflow channel 58 and the saturation vapor pressure of the phase change material 80 at the surface of the selectively permeable membrane 60 may drive latent heat transfer from the coolant 30 to the airflow 44. In practice, latent heat transfer from the coolant 30 to the airflow 44 may occur via evaporation of the phase change material 80 from the coolant 30, through the selectively permeable membrane 60, and into the airflow 44 flowing through the airflow channel 58. Evaporation of the phase change material 80 from the coolant 30 and the introduction of the phase change material 80 into the airflow 44 may decrease the temperature of the coolant 30 without increasing the temperature of the airflow 44. The amount of latent heat that can be transferred from the coolant 30 to the airflow 44 flowing through the airflow channel 58 depends on the latent heat of vaporization of the phase change material 80 in the coolant 30 and on the mass of the phase change material 80 that can be introduced into the airflow 44 in the airflow channel 58 before saturation. Evaporation of the phase change material 80 from the coolant 30 into the airflow 44 will increase the vapor pressure of the phase change material 80 in the airflow 44 flowing through the airflow channel 58. Once the saturation vapor pressure of the phase change material 80 is reached in the airflow 44 flowing through the airflow channel 58, no additional evaporation will occur. In embodiments where the phase change material 80 in the coolant 30 comprises or consists essentially of water, the saturation vapor pressure is reached at 100% relative humidity.

As shown in FIG. 4, in some embodiments, the auxiliary evaporative cooler 22 may include a thermal energy storage chamber 82 in fluid communication with the airflow channel 58. The thermal energy storage chamber 82 is configured to store thermal energy released from the coolant 30 flowing through the coolant channel 52 in the form of latent heat. For example, in some embodiments, at least some of the phase change material 80 evaporated from the coolant 30 may be stored in gaseous form in the thermal energy storage chamber 82. The thermal energy storage chamber 82 may provide the auxiliary evaporative cooler 22 with a relatively large volume of space between the airflow inlet 54 and the airflow outlet 56 where gases of the phase change material 80 flowing through the airflow channel 58 can be stored. As such, the thermal energy storage chamber 82 may increase the amount of the phase change material 80 that can be evaporated from the coolant 30 flowing through the coolant channel 52 into the airflow 44 flowing through the airflow channel 58 prior to reaching the saturation vapor pressure of the phase change material 80 in the airflow 44 flowing through the airflow channel 58. In addition, the thermal energy storage chamber 82 may increase the evaporation rate of the phase change material 80 from the coolant 30 (the mass or volume of the phase change material 80 that can be evaporated from the coolant 30 per unit time) without increasing the volumetric flow rate of the airflow 44 flowing through the airflow channel 58 (and without increasing the volumetric flow rate of the airflow 44 through the plenum 18). Increasing the evaporation rate of the phase change material 80 from the coolant 30 may increase the amount and rate at which heat can be removed from the coolant 30.

In situations where the aircraft 2 is operating under high load conditions, operation of the auxiliary evaporative cooler 22 may increase the cooling rate of the coolant 30, which may help compensate for circumstances in which the heat generation rate of the fuel cell 12 is relatively high, for example, which may occur when the aircraft 2 is operating under high load conditions. Operation of the auxiliary evaporative cooler 22 when the aircraft 2 is operating under high load conditions may help maintain the coolant 30 at a desirable operating temperature within the cooling system 10 by removing excess waste heat therefrom. The auxiliary evaporative cooler 22 can effectively remove excess waste heat from the cooling system 10 when the aircraft 2 is operating under high load conditions without increasing the volumetric flow rate of ambient air directed through the aircraft 2 (e.g., through the plenum 18), and thus without increasing the amount of drag experienced by the aircraft 2, which may increase the overall energy efficiency of the aircraft 2. In the embodiment depicted in FIG. 4, the thermal energy storage chamber 82 is adjacent the airflow channel 58 and extends along a length of the airflow channel 58; however, other arrangements are possible so long as the thermal energy storage chamber 82 is in fluid communication with the airflow channel 58.

In some embodiments, the thermal energy storage chamber 82 may be spaced apart from the airflow channel 58 and the coolant channel 52 within the aircraft 2 and fluid communication between the thermal energy storage chamber 82 and the airflow channel 58 may be provided by an intermediate passageway. Spacing the thermal energy storage chamber 82 apart from the airflow channel 58 and the coolant channel 52 within the aircraft 2 may allow the thermal energy storage chamber 82 to be located in an otherwise unused voluminous region of the aircraft 2, for example, in the wings 6. In aircraft powered by combustion engines, the liquid fuel (e.g., gasoline or kerosine) for engine operation is oftentimes stored in the wings of the aircraft. The aircraft 2 depicted in FIG. 2, however, is powered by the fuel cell 12 and thus does not need to store large volumes of liquid fuel in the wings 6. The thermal energy storage chamber 82 may be located within one or both of the wings 6 of the aircraft 2 to provide the cooling system 10 with the ability to rapidly transfer thermal energy away from the coolant 30 when the aircraft 2 is operating under relatively high load conditions. In addition, the thermal energy storage chamber 82 may be located within one or both of the wings 6 of the aircraft 2 to provide the cooling system 10 with the ability to store the thermal energy released from the coolant 30 within the aircraft 2 itself in the form of latent heat. The thermal energy storage chamber 82 may be relatively large in volume, as compared to the volume of the auxiliary evaporative cooler 22 and/or of the liquid-to-air heat exchanger 20. As such, the thermal energy storage chamber 82 may provide the cooling system 10 with adequate cooling capabilities, without increasing the size of the liquid-to-air heat exchanger 20 and without adding additional weight and/or bulk to the cooling system 10.

The thermal energy storage chamber 82 may be sized to compensate for the increased waste heat generation rate of the fuel cell 12 when the aircraft 2 is operating under high load conditions by storing excess waste heat generated by the fuel cell 12 in the form of latent heat. Once the saturation vapor pressure of the phase change material 80 is reached within the thermal energy storage chamber 82, no additional evaporation will occur. As such, once the saturation vapor pressure of the phase change material 80 is reached within the thermal energy storage chamber 82, the thermal energy storage chamber 82 will reach its maximum energy storage capacity. In embodiments where the phase change material 80 in the coolant 30 comprises or consists essentially of water, the thermal energy storage chamber 82 will reach a maximum energy storage capacity when air in the thermal energy storage chamber 82 reaches 100% relative humidity. The volume of the thermal energy storage chamber 82 may be sized to achieve a desired energy storage capacity. For example, the energy storage capacity, H, of the thermal energy storage chamber 82 at a known temperature and pressure may be calculated by the following formula:

H=SVD×V×Lᵥ (1)
where H is the energy storage capacity (J), SVD is the saturation vapor density (g/m³) of the phase change material 80, V is the volume (m³) of the thermal energy storage chamber 82, and Ly is the specific latent heat of vaporization (J/g) of the phase change material 80.

The aircraft 2 may periodically operate under relatively high load conditions for certain established periods of time during certain types of events (e.g., during takeoff and climb). The waste heat generation rate of the fuel cell 12 may increase during such high load events by a known amount, as compared to the waste heat generation rate of the fuel cell 12 during relatively low load events (e.g., during cruise and/or descent). The overall amount of additional thermal energy generated by the fuel cell 12 during a single one of such high load events may be calculated based upon the duration of the event and the increase in the waste heat generation rate of the fuel cell 12. In some embodiments, the volume of the thermal energy storage chamber 82 may be sized to achieve a thermal energy storage capacity that is greater than or equal to the amount of additional thermal energy generated by the fuel cell 12 during a single high load event.

As shown in FIG. 4, the thermal energy storage chamber 82 may increase the cross-sectional area of the path of the airflow 44 (defined perpendicular to the flow direction of the airflow 44 through the airflow channel 58) between the airflow inlet 54 and the airflow outlet 56 as well as the overall volume of space the airflow 44 can occupy between the airflow inlet 354 and the airflow outlet 356 of the auxiliary evaporative cooler 22. Because the volumetric flow rate of the airflow 44 flowing through the airflow channel 58 between the airflow inlet 54 and the airflow outlet 56 is constant, the thermal energy storage chamber 82 may decrease the velocity of the airflow 44 within the auxiliary evaporative cooler 22 and thereby increase the residence time of a given volume of air within the auxiliary evaporative cooler 322. As such, the thermal energy storage chamber 82 may allow vapors of the phase change material 80 that have been introduced into and stored in the thermal energy storage chamber 82 to be gradually dissipated or discharged from the airflow outlet 56 of the auxiliary evaporative cooler 22 over time. Discharging at least a portion of the phase change material 80 from the thermal energy storage chamber 82 will reduce the vapor pressure of the phase change material 80 in the thermal energy storage chamber 82. Reducing the vapor pressure of the phase change material 80 in the thermal energy storage chamber 82 to below the saturation vapor pressure will at least partially regenerate or recharge the thermal energy storage chamber 82 so that the thermal energy storage chamber 82 can store additional thermal energy in the form of latent heat.

In some embodiments, the thermal energy storage chamber 82 may be physically separated from the airflow channel 58 by a partition 84. In such case, the controller 26 may control operation of the partition 84 based upon information received, for example, from the temperature sensor 34. For example, when the temperature sensor 34 indicates that the temperature of the coolant 30 is below a defined temperature limit, the controller 26 may control operation of the partition 84 so that the partition 84 is in a closed position (FIG. 4) and the airflow 44 flowing through the airflow channel 58 does not enter the thermal energy storage chamber 82. On the other hand, when the temperature sensor 34 indicates that the temperature of the coolant 30 is above a defined temperature limit, the controller 26 may control operation of the partition 84 so that the partition 84 is in an open position (not shown) and the airflow 44 flowing through the airflow channel 58 can enter the thermal energy storage chamber 82. When the partition 84 is in the open position, phase change material 80 that has evaporated from the coolant 30 through the selectively permeable membrane 60 may be able to enter the thermal energy storage chamber 82 for temporary storage.

FIG. 5 depicts another embodiment of an auxiliary evaporative cooler 322, including a coolant inlet 348, a coolant outlet 350, a coolant channel 352, an airflow inlet 354, an airflow outlet 356, an airflow channel 358, and a selectively permeable membrane 360. The auxiliary evaporative cooler 322 is similar in many respects to the auxiliary evaporative cooler 22 depicted in FIG. 1 and a description of common subject matter generally may not be repeated here. The coolant inlet 348 and the coolant outlet 350 are in fluid communication with the coolant circuit 14 and the coolant channel 352 is defined between the coolant inlet 348 and the coolant outlet 350. The airflow inlet 354 and the airflow outlet 356 in fluid communication with the inlet 40 and the outlet 42 of the plenum 18 and the airflow channel 358 is defined between the airflow inlet 354 and the airflow outlet 356. The selectively permeable membrane 360 is disposed between and physically separates the coolant channel 352 from the airflow channel 358. In the embodiment depicted in FIG. 5, a thermal energy storage chamber 382 is at least partially defined by the airflow channel 358 and is positioned in-line with the airflow channel 358. In practice, the airflow 44 is introduced into the airflow inlet 354 of the airflow channel 358 and is directed through the thermal energy storage chamber 382 prior to being discharged from the airflow outlet 356. In some embodiments, the thermal energy storage chamber 382 may circumscribe the airflow channel 358.

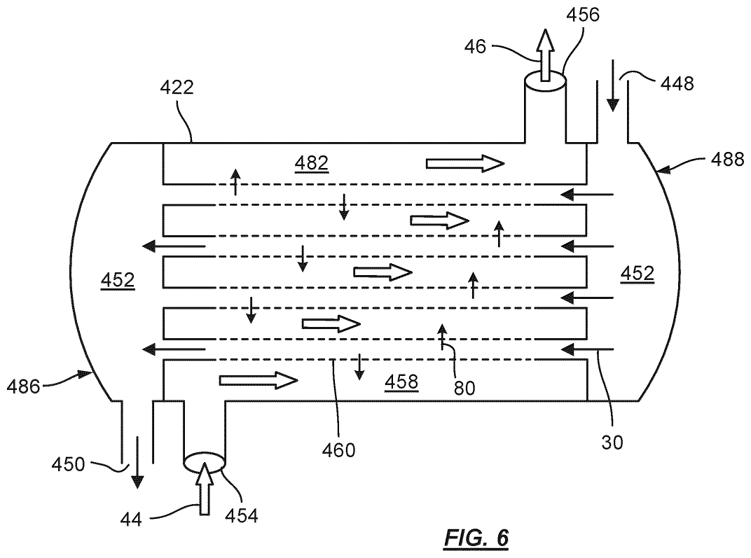

FIG. 6 depicts another embodiment of an auxiliary evaporative cooler 422, having a first end 486, an opposite second end 488, a coolant inlet 448, a coolant outlet 450, a plurality of coolant channels 452, an airflow inlet 454, an airflow outlet 456, a plurality of airflow channels 458, and a plurality of selectively permeable membranes 460. The auxiliary evaporative cooler 422 is similar in many respects to the auxiliary evaporative cooler 22 depicted in FIG. 1 and a description of common subject matter generally may not be repeated here. The coolant inlet 448 and the coolant outlet 450 are in fluid communication with the coolant circuit 14 and the plurality of coolant channels 452 extend parallel to one another between the coolant inlet 448 and the coolant outlet 450. In practice, the coolant 30 is introduced into the coolant inlet 448 at the second end 488 of the auxiliary evaporative cooler 422 and coolant 30 is discharged from the coolant outlet 450 at the first end 486 of the auxiliary evaporative cooler 422. The airflow inlet 454 and the airflow outlet 456 are in fluid communication with the inlet 40 and the outlet 42 of the plenum 18 and the plurality of airflow channels 458 extend parallel to one another between the airflow inlet 454 and the airflow outlet 456. In practice, the airflow 44 is introduced into the airflow inlet 454 at the first end 486 of the auxiliary evaporative cooler 422 and the processed airflow 46 is discharged from the airflow outlet 456 at the second end 488 of the auxiliary evaporative cooler 422. In the auxiliary evaporative cooler 422, the airflow 44 flows in a first direction from the airflow inlet 454 to the airflow outlet 456 and the coolant 30 flow in a second direction opposite the first direction from the coolant inlet 448 to the coolant outlet 450. Each of the plurality of coolant channels 452 is physically separated from an adjacent one of the plurality of airflow channels 458 by one of the plurality of selectively permeable membranes 460. In the embodiment depicted in FIG. 6, a thermal energy storage chamber 482 is at least partially defined by the plurality of airflow channels 458 extending between the airflow inlet 454 and the airflow outlet 456. In practice, the airflow 44 is introduced into the airflow inlet 454 and directed through the plurality of airflow channels 458 and through the thermal energy storage chamber 482 prior to being discharged from the airflow outlet 456.

The fuel cell 12 includes an anode 62 and a cathode 64 separated by an ionically conductive electrolyte (not shown). The anode 62 is configured to receive a hydrogen-containing reactant gas 66 and to discharge a hydrogen-containing exhaust gas stream 68. The cathode 64 is configured to receive an oxygen-containing reactant gas 70 and to discharge a water vapor-containing exhaust gas stream 72. During operation of the fuel cell 12, hydrogen in the hydrogen-containing reactant gas 66 is oxidized at the anode 62, producing positively charged ions (e.g., hydrogen ions) and electrons. The positively charged hydrogen ions travel through the ionically conductive electrolyte from the anode 62 to the cathode 64, while the electrons simultaneously travel from the anode 62 to the cathode 64 outside the fuel cell 12 via an external circuit (not shown), which produces an electric current. The electric current generated during operation of the fuel cell 12 may be used to power the electric motor 4 onboard the aircraft 2. On the cathode 64 side of the fuel cell 12, The oxygen-containing reactant gas 70 is reduced by the electrons arriving from the external circuit and combined with the positively charged hydrogen ions to form water vapor, which is discharged from the fuel cell 12 in the form of the water vapor-containing exhaust gas stream 72. The reaction between oxygen and hydrogen at the cathode 64 is exothermic, which generates heat.

The fuel cell heat exchanger 24 is thermally coupled to the fuel cell 12 and is configured to transfer heat from the fuel cell 12 to the coolant 30 circulating through the coolant circuit 14 during operation of the cooling system 10 to help maintain the fuel cell 12 within a desired operating temperature range.

In embodiments where the phase change material 80 comprises or consists essentially of water, the airflow 44 discharged from the airflow outlet 56 of the auxiliary evaporative cooler 22 may contain water vapor. In such case, the coolant 30 may need to be replenished with water to account for water lost therefrom during operation of the auxiliary evaporative cooler 22. In some embodiments, the coolant 30 may be replenished with water by manual addition thereto. In other embodiments, the optional water recovery system 28 may be used to replenish the coolant 30 with at least a portion of the water lost therefrom during operation of the auxiliary evaporative cooler 22.

The optional water recovery system 28 is configured to recover water vapor from one or more water vapor-containing streams generated within the aircraft 2 to replace or supplement water vapor evaporated from the coolant 30 in the coolant circuit 14 during operation of the auxiliary evaporative cooler 22. For example, the water recovery system 28 may be used to recover water vapor from the water vapor-containing exhaust gas stream 72 discharged from the cathode 64 of the fuel cell 12 or from the water vapor-containing processed airflow 46 discharged from the airflow outlet 56 of the auxiliary evaporative cooler 22 (or from the outlet 42 of the plenum 18). In FIG. 1, the water recovery system 28 is constructed and arranged to recover water vapor from the water vapor-containing exhaust gas stream 72 discharged from the cathode 64 of the fuel cell 12. The water recovery system 28 may include a condenser 74 and a separator 76. The condenser 74 may be configured to cool the water vapor-containing exhaust gas stream 72 and condense the water vapor contained therein to a liquid. The separator 76 may be positioned downstream of the condenser 74 and may be configured to separate the liquid water from the other components of the exhaust gas stream 72. In some embodiments, the liquid water condensate may be discharged from the separator 76 and supplied to the coolant header tank 16.

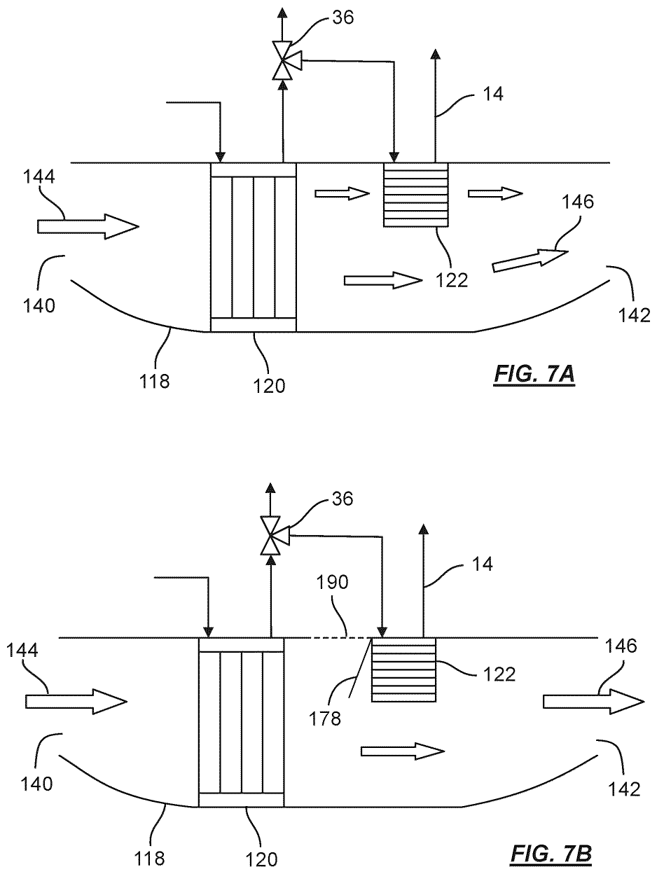

FIGS. 7A and 7B depict another embodiment of a plenum 118, including a liquid-to-air heat exchanger 120 and an auxiliary evaporative cooler 122 arranged in series in the airflow path defined between an inlet 140 and an outlet 142 of the plenum 118. The plenum 118, the liquid-to-air heat exchanger 120, and the auxiliary evaporative cooler 122 are similar in many respects to the plenum 18, the liquid-to-air heat exchanger 20, and the auxiliary evaporative cooler 22 depicted in FIG. 1, and a description of common subject matter generally may not be repeated here.

Like the plenum 18, the plenum 118 includes an inlet 140 configured to receive an airflow 144 of ambient air from an ambient environment outside the aircraft 2 and an outlet 142 configured to discharge a processed airflow 146 from the plenum 118, for example, to the ambient environment. The liquid-to-air heat exchanger 120 is configured to promote indirect heat transfer between the coolant 30 circulating through the coolant circuit 14 of the cooling system 10 and the airflow 144 passing through the plenum 118. The auxiliary evaporative cooler 122 is configured to evaporatively cool the coolant 30 circulating through the coolant circuit 14. The controller 26 may control operation of the bypass valve 36 so that the coolant 30 exiting the liquid-to-air heat exchanger 120 either bypasses the auxiliary evaporative cooler 122 or is directed through the auxiliary evaporative cooler 122.

In FIG. 1, the liquid-to-air heat exchanger 20 and the auxiliary evaporative cooler 22 are arranged in series in the airflow path defined between an inlet 40 and an outlet 42 of the plenum 18, with both the liquid-to-air heat exchanger 20 and the auxiliary evaporative cooler 22 extending substantially entirely across a cross-section of the plenum 18 perpendicular to the airflow path between the inlet 40 and the outlet 42 thereof. In FIG. 7A, the liquid-to-air heat exchanger 120 extends substantially entirely across a cross-section of the plenum 118 perpendicular to the airflow path between the inlet 140 and the outlet 142 thereof; however, the auxiliary evaporative cooler 122 only extends part-way across a cross-section of the plenum 118. As such, substantially all of the airflow 144 introduced into the inlet 140 of the plenum 118 passes through the liquid-to-air heat exchanger 120, but only a portion of the airflow 144 introduced into the inlet 140 of the plenum 118 passes through the auxiliary evaporative cooler 122.

In FIG. 7B, a bypass member 178 has been opened and brought down in front of an inlet face of the auxiliary evaporative cooler 122 so that the airflow 144 introduced into the inlet 140 of the plenum 118 bypasses the auxiliary evaporative cooler 122 and does not pass through the auxiliary evaporative cooler 122. In some embodiments, when the bypass member 178 is in the open position, an aperture 190 may be defined in the plenum 18, which may provide an alternate outlet for the airflow 44 to be discharged from the plenum 18, which may reduce the pressure within the plenum 18 downstream of the liquid-to-air heat exchanger 120. In some embodiments, the bypass member 178 may be a discrete component of the aircraft 2 and may be transitioned to an open position in which the bypass member 178 serves principally to block the inlet face of the auxiliary evaporative cooler 122, without creating an alternate outlet for the airflow 44 to exit the plenum 18. In some embodiments, when the bypass member 178 is in a closed position, the bypass member 178 may be stored within or adjacent a wall of the plenum 18.

In some embodiments, the controller 26 may control operation of the bypass member 178 so that the airflow 144 introduced into the plenum 118 either bypasses the auxiliary evaporative cooler 122 or is allowed to pass through the auxiliary evaporative cooler 122. For example, operation of the bypass valve 36 and the bypass member 178 may be controlled by the controller 26 so that, when the temperature sensor 34 indicates that the temperature of the coolant 30 is above a defined temperature limit, the coolant 30 exiting the liquid-to-air heat exchanger 120 is directed by the bypass valve 36 through the auxiliary evaporative cooler 122 and the bypass member 178 is closed (FIG. 7A) so that the airflow 144 introduced into the plenum 118 is allowed to pass through the auxiliary evaporative cooler 122. In such an arrangement, the auxiliary evaporative cooler 122 can help transfer excess heat away from the coolant 30, for example, which may be beneficial when the aircraft 2 is operating under high load conditions and the fuel cell 12 is generating relatively high amounts of heat. On the other hand, when the temperature sensor 34 indicates that the temperature of the coolant 30 is below a defined temperature limit, operation of the bypass valve 36 and the bypass member 178 may be controlled so that the coolant 30 exiting the liquid-to-air heat exchanger 120 is directed by the bypass valve 36 to bypass the auxiliary evaporative cooler 122 and the bypass member 178 is open (FIG. 7B) so that the airflow 144 introduced into the plenum 118 is directed by the bypass member 178 to bypass the auxiliary evaporative cooler 122. In such an arrangement, additional drag imparted to the aircraft 2 by the auxiliary evaporative cooler 122 can be reduced or eliminated when the aircraft 2 is operating under normal or low load conditions and the fuel cell 12 is generating relatively low amounts of heat.

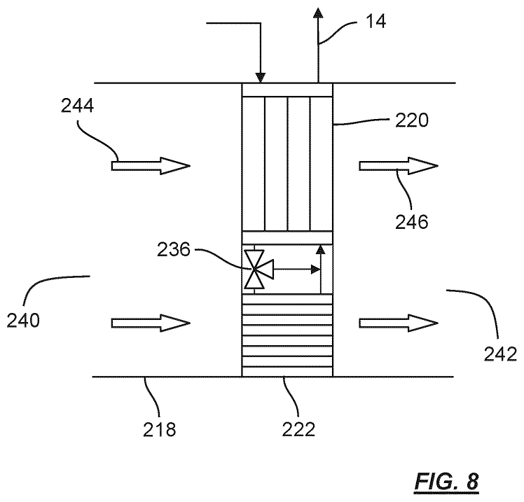

FIG. 8 depicts another embodiment of a plenum 218, including a liquid-to-air heat exchanger 220 and an auxiliary evaporative cooler 222 arranged in parallel in the airflow path defined between an inlet 240 and an outlet 242 of the plenum 218. The plenum 218, the liquid-to-air heat exchanger 220, and the auxiliary evaporative cooler 222 are similar in many respects to the plenum 18, the liquid-to-air heat exchanger 20, and the auxiliary evaporative cooler 22 depicted in FIG. 1, and a description of common subject matter generally may not be repeated here.

Like the plenum 18, the plenum 218 includes an inlet 240 configured to receive an airflow 244 of ambient air from an ambient environment outside the aircraft 2 and an outlet 242 configured to discharge a processed airflow 246 from the plenum 218, for example, to the ambient environment. The liquid-to-air heat exchanger 220 is configured to promote indirect heat transfer between the coolant 30 circulating through the coolant circuit 14 of the cooling system 10 and the airflow 244 passing through the plenum 218. The auxiliary evaporative cooler 222 is configured to evaporatively cool the coolant 30 circulating through the coolant circuit 14. The controller 26 may control operation of a bypass valve 236 so that the coolant 30 exiting the liquid-to-air heat exchanger 220 either bypasses the auxiliary evaporative cooler 222 or is directed through the auxiliary evaporative cooler 222.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cooling system for a fuel cell onboard a vehicle, the cooling system comprising:
a coolant circuit defining a coolant passageway, the coolant circuit being configured to circulate a coolant including a phase change material through the coolant passageway and through a portion of the fuel cell to absorb heat from the fuel cell; and
an auxiliary evaporative cooler comprising:
an inlet configured to receive an airflow from an ambient environment;
an outlet in fluid communication with the inlet and with the ambient environment;
a coolant channel in fluid communication with the coolant circuit;
an airflow channel in fluid communication with the inlet and the outlet; and
a selectively permeable membrane that physically separates the coolant channel from the airflow channel, the selectively permeable membrane being selectively permeable to the phase change material in the coolant,
wherein the auxiliary evaporative cooler is configured to evaporatively cool the coolant flowing through the coolant channel by promoting evaporation and transport of the phase change material from the coolant flowing through the coolant channel, through the selectively permeable membrane, and into the airflow flowing through the airflow channel.

2. The cooling system of claim 1, further comprising:
a thermal energy storage chamber in fluid communication with the airflow channel, wherein the thermal energy storage chamber is configured to store thermal energy released from the coolant flowing through the coolant channel in the form of latent heat.

3. The cooling system of claim 2, wherein the thermal energy storage chamber is configured to store phase change material evaporated from the coolant flowing through the coolant channel when the vehicle is operating under high load conditions and to gradually discharge the phase change material therefrom when the vehicle is operating under low load conditions.

4. The cooling system of claim 2, wherein, during a high load event, an additional amount of thermal energy is generated by the fuel cell, as compared to when the vehicle is operating under normal conditions or relatively low load conditions for the same duration, and wherein the thermal energy storage chamber is sized such that a thermal energy storage capacity of the thermal energy storage chamber is greater than or equal to the additional amount of thermal energy generated by the fuel cell during the high load event.

5. The cooling system of claim 2, wherein storage of the phase change material within the thermal energy storage chamber increases an evaporation rate of the phase change material from the coolant without increasing a volumetric flow rate of the airflow through the airflow channel.

6. The cooling system of claim 2, wherein the thermal energy storage chamber reaches a maximum energy storage capacity when the vapor pressure of the phase change material in the thermal energy storage chamber reaches the saturation vapor pressure of the phase change material.

7. The cooling system of claim 1, wherein the phase change material comprises water and the selectively permeable membrane comprises a hydrophobic polymer.

8. The cooling system of claim 7, further comprising:
a water recovery system configured to: (i) condense water vapor from a processed airflow exiting the outlet of the auxiliary evaporative cooler and to return the condensed water vapor to the coolant circuit, or (ii) to condense water vapor from a cathode exhaust gas stream generated by operation of the fuel cell and to supply the condensed water to the coolant circuit.

9. The cooling system of claim 1, further comprising:
a plenum including an inlet and an outlet in fluid communication with the ambient environment, wherein the inlet of the plenum is in fluid communication with the inlet of the auxiliary evaporative cooler and the outlet of the plenum is in fluid communication with the outlet of the auxiliary evaporative cooler.

10. The cooling system of claim 9, wherein the coolant circuit comprises a first bypass configured to direct the coolant circulating through the coolant passageway to selectively bypass the auxiliary evaporative cooler, and wherein the plenum comprises a second bypass configured to direct the airflow flowing through the plenum to selectively bypass the auxiliary evaporative cooler.

11. The cooling system of claim 10, further comprising:
a controller configured to control operation of the first bypass and the second bypass such that (i) the airflow and the coolant pass through the auxiliary evaporative cooler when the vehicle is operating under high load conditions, and (ii) the airflow and the coolant bypass the auxiliary evaporative cooler when the vehicle is operating under low load conditions.

12. The cooling system of claim 9, wherein the auxiliary evaporative cooler is disposed within the plenum, and wherein the inlet of the plenum is configured to receive the airflow from the ambient environment when the vehicle is moving.

13. The cooling system of claim 12, wherein the vehicle is an aircraft, the airflow comprises ram air, and the plenum is defined within a wing of the aircraft.

14. A cooling system for a fuel cell onboard a vehicle, the cooling system comprising:
a plenum including an inlet and an outlet in fluid communication with an ambient environment, wherein the inlet is configured to receive an airflow from the ambient environment;
a coolant circuit defining a coolant passageway, the coolant circuit being configured to circulate an aqueous coolant through the coolant passageway and through a portion of the fuel cell to absorb heat from the fuel cell; and
an auxiliary evaporative cooler comprising:
a coolant channel in fluid communication with the coolant circuit;
an airflow channel in fluid communication with the inlet and the outlet of the plenum; and
a selectively permeable membrane that physically separates the coolant channel from the airflow channel, the selectively permeable membrane being selectively permeable to water vapor; and
a thermal energy storage chamber in fluid communication with the airflow channel of the auxiliary evaporative cooler,
wherein the auxiliary evaporative cooler is configured to evaporatively cool the aqueous coolant flowing through the coolant channel by promoting evaporation and transport of water vapor from the aqueous coolant flowing through the coolant channel, through the selectively permeable membrane, and into the airflow flowing through the airflow channel, and
wherein the thermal energy storage chamber is configured to store thermal energy released from the aqueous coolant flowing through the coolant channel in the form of latent heat.

15. The cooling system of claim 14, wherein the thermal energy storage chamber is configured to store water vapor evaporated from the aqueous coolant flowing through the coolant channel when the vehicle is operating under high load conditions and to gradually discharge the water vapor therefrom when the vehicle is operating under low load conditions.

16. The cooling system of claim 14, wherein storage of the water vapor within the thermal energy storage chamber increases the rate at which thermal energy is removed from the coolant flowing through the coolant channel without increasing a volumetric flow rate of the airflow flowing through the airflow channel.

17. The cooling system of claim 14, wherein the thermal energy storage chamber reaches a maximum energy storage capacity when the vapor pressure of water in the thermal energy storage chamber reaches the saturation vapor pressure of water.

18. The cooling system of claim 14, wherein, during a high load event, an additional amount of thermal energy is generated by the fuel cell, as compared to when the vehicle is operating under normal conditions or relatively low load conditions for the same duration, and wherein the thermal energy storage chamber is sized such that a thermal energy storage capacity of the thermal energy storage chamber is greater than or equal to the additional amount of thermal energy generated by the fuel cell during the high load event.

19. The cooling system of claim 14, wherein the aqueous coolant comprises a mixture of water and at least one of ethylene glycol and propylene glycol.

20. The cooling system of claim 14, wherein the vehicle is an aircraft, the airflow comprises ram air, the plenum is defined within a wing of the aircraft, and the thermal energy storage chamber is disposed within the plenum.
